(19) United States
(12) Patent Application Publication
(10) Pub. No.: US 2017/0267234 A1
(43) Pub. Date: Sep. 21, 2017

(54) SYSTEMS AND METHODS FOR PROVIDING COLLISION AVOIDANCE OR MITIGATION

(71) Applicant: Soterea, Inc., Cranbury, NJ (US)

(72) Inventors: James W. Kemp, Madison, NJ (US); Carlos M. Antunes, Union, NJ (US)

(73) Assignees: Soterea, Inc., Cranbury, NJ (US); Soterea, Inc., Cranbury, NJ (US)

(21) Appl. No.: 15/461,841

(22) Filed: Mar. 17, 2017

Related U.S. Application Data
(60) Provisional application No. 62/309,998, filed on Mar. 18, 2016.

(51) Int. Cl. B60W 30/09; B60W 50/16; G08G 1/16; B60W 10/04; B60W 10/18

(52) U.S. Cl. CPC B60W 30/09; B60W 10/04; B60W 10/182; G08G 1/165; G08G 1/166; B60W 50/16; B60W 2050/143

(57) ABSTRACT

Systems and methods for controlling a vehicle's speed. The methods comprise: obtaining sensor data by an Aftermarket Electronic Controller (“AEC”) that was installed in the vehicle after the vehicle's sale to a consumer; processing by AEC the sensor data to determine if there is a Collision Risk (“CR”) of the vehicle colliding with a Possible Obstruction (“PO”); calculating by AEC an estimated time until PO and the vehicle will collide, when a determination is made that there is a CR; performing first operations by the AEC to transition the vehicle's operational state to a collision warning state in which a warning device is activated, when the estimate time is greater than a threshold value; and performing second operations by AEC to transition the vehicle's operational state to a collision avoidance state in which a speed retarder is engaged, when the estimated time is less than the threshold value.

### CROSS-REFERENCE TO RELATED APPLICATIONS

This application claims priority to U.S. Provisional Patent Application No. 62/309,998 filed on Mar. 18, 2016. The content of the above patent application is incorporated by reference in its entirety.

### BACKGROUND

Statement of the Technical Field

The present disclosure concerns generally to vehicles. More particularly, the present invention relates to implementing systems and methods for providing collision avoidance or mitigation that can be implemented in vehicles.

Description of the Related Art

Collisions involving heavy vehicles and in particular, rear-end collisions, cause property damage, injury, and death across the world's roadways. In many instances, rear-end collisions are caused by driver inattentiveness and fatigue. However, loss of foundation brakes due to overheated or glazed brake shoes and linings also account for many such collisions. Collisions can be reduced (if not avoided completely) with the correct technology installed on ground transportation vehicles. Furthermore, equipping older fleets on an after-market basis confers the same safety benefits that new vehicle technology already installed at the factory provides, without the large financial commitment of purchasing a new fleet. Although some vehicle manufacturers now offer collision avoidance systems on their vehicles, these have limitations. The systems can be costly and are only available on new equipment. The systems offered by vehicle manufacturers also have limitations in their effectiveness, since they are by default based on the vehicle's foundation braking systems and cruise control. For example, the collision avoidance described in U.S. Pat. No. 7,016,783 to Hac (“the '783 patent”), relies on the vehicle's foundation braking system to reduce vehicle speed. Additionally, foundation braking systems can be disabled by the driver, potentially reducing the safety and financial and health benefits achieved by deterministically modifying driving behavior.

### SUMMARY

The present invention concerns implementing systems and methods for controlling a speed of a vehicle. The methods comprise obtaining sensor data from at least one sensor of the vehicle by an aftermarket electronic controller that was installed in the vehicle after the vehicle's sale to a consumer. The sensor data is processed by the aftermarket electronic controller to determine if there is a collision risk of the vehicle colliding with a possible obstruction. In some scenarios, the collision risk is determined based on at least one of a size of the possible obstruction, changes in a distance between the vehicle and the possible obstruction, a path of travel of the vehicle, and the possible obstruction's relative distance to the vehicle at a given time.

If a determination is made that there is a collision risk, then the aftermarket electronic controller calculates an estimated time until the possible obstruction and the vehicle will collide with each other. When the estimated time is greater than a threshold value, the aftermarket electronic controller performs first operations to transition an operational state of the vehicle to a collision warning state in which a warning device is activated for outputting a visual, tactile or auditory collision warning. When the estimated time is less than the threshold value, the aftermarket electronic controller performs second operations to transition the operational state of the vehicle to a collision avoidance state in which a speed retarder is engaged so as to slow a speed of the vehicle without human intervention and without reliance on the vehicle's foundation braking system. The speed retarder can include, but is not limited to, an Electro-Magnetic Drive Shaft Retarding Mechanism (“EMDSRM”) configured to apply torque to a main drive shaft of the vehicle in order to reduce the main drive shaft's speed of rotation.

In some scenarios, the aftermarket electronic controller also performs operations to: cause a park brake valve auto apply system to bring the vehicle to a stop if the collision risk still exists after the speed retarder has been engaged; cause an engine control unit to inhibit the vehicle's throttle when a pre-defined period of time has expired after the operational state of the vehicle is transitioned to the collision warning state; automatically and dynamically modify at least one operating parameter based on at least one of a vehicle weight, a sensed driver response time, a tire's traction and a braking effectiveness; and/or set a collision avoidance sensitivity based on a received a user-software interaction.

In those or other scenarios, the aftermarket electronic controller further performs operations to: determine if the collision risk has been eliminated as a result of the vehicle's throttle inhibition; and transition the operational state of the vehicle from the collision warning state to the collision avoidance state of the collision risk has not been eliminated as a result of the vehicle's throttle inhibition. Alternatively or additionally, the aftermarket electronic controller also performs operations to: detect an abnormal discrepancy between a drive shaft rotational deceleration and an actual vehicle deceleration; and cause the speed retarder to reduce retarder power or become disengaged in response to the detection of the abnormal discrepancy.

In those or yet other scenarios, the aftermarket electronic controller also performs operations to: detect application of an anti-locking braking system; and cause the speed retarder to reduce retarder power and maintain a maximum achievable braking torque without activating the anti-locking braking system while slowing the vehicle to prevent collision.

### BRIEF DESCRIPTION OF THE DRAWINGS

Embodiments will be described with reference to the following drawing figures, in which like numerals represent like items throughout the figures.

FIG. 1 is an illustration of an exemplary vehicle.

FIG. 2 is an illustration of an exemplary architecture for a forward collision avoidance system.

FIG. 3 is an illustration of an exemplary architecture for a controller.

FIG. 4 is an illustration of an exemplary architecture for an electronic air solenoid valve.

FIG. 5 is an illustration of an exemplary architecture for a park brake valve.

FIGS. 6A-6B (collectively referred to herein as “FIG. 6”) provides a flow diagram of an exemplary method for forward collision avoidance to be implemented in a vehicle.

FIG. 7 provides a flow diagram of an exemplary method for operating a speed retarder.

FIG. 8 provides a flow diagram of another exemplary method for operating a speed retarder.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

Furthermore, the described features, advantages and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

While current collision avoidance systems rely on a vehicle's foundation braking system to slow the vehicle, the present solution described here uses a drive shaft retarder to slow the vehicle. The use of a drive shaft retarder enables collision avoidance technology to be installed in vehicles on an after-market basis. Up to this point, after-market manufacturers have only installed collision warning systems, in which the driver is alerted to a collision, but the system does not control the vehicle in any way to avoid or mitigate the collision. For example, one of the reasons existing after-market systems only provide warning is because the safety threshold required to control a vehicle's foundation braking system after the time of manufacture is often unattainable. If the after-market system failed in any way, it would affect the car's only braking system. The present solution described here provides the ability for vehicle speed to be reduced without using the foundation braking system, and thereby leaves the foundation braking system under the driver's control and under the original manufacturer warranty. The present solution can be installed on an after-market basis, providing collision avoidance for existing vehicles.

The present solution is described herein in relation to forward collision avoidance. The present solution is not limited in this way, and can be employed in other applications. For example, the present solution is used for side collision avoidance, rear collision avoidance in which a vehicle is moving in reverse, and/or height restriction avoidance detection). Alternatively, the present solution is used for collision mitigation rather than avoidance. In this case, the system parameters providing the speed retarder are adjusted such that the vehicle speed would be reduced, but that a collision would still occur at a relatively slow speed.

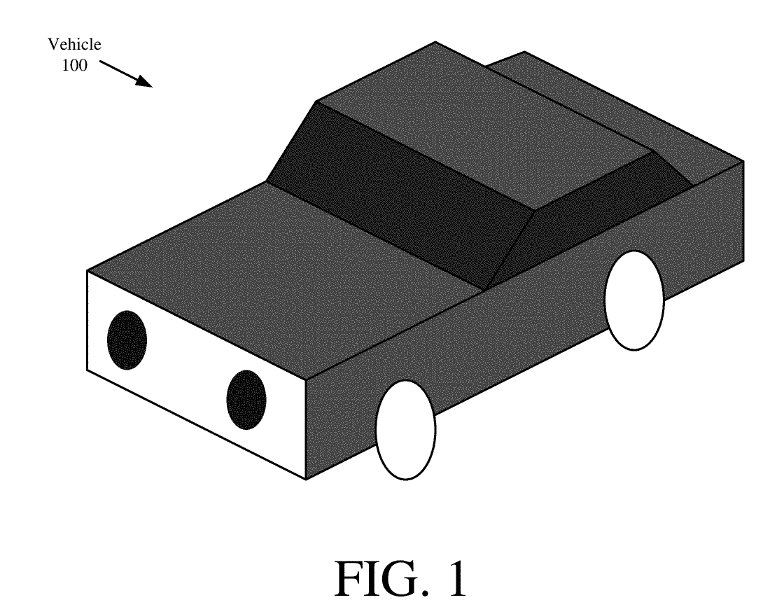

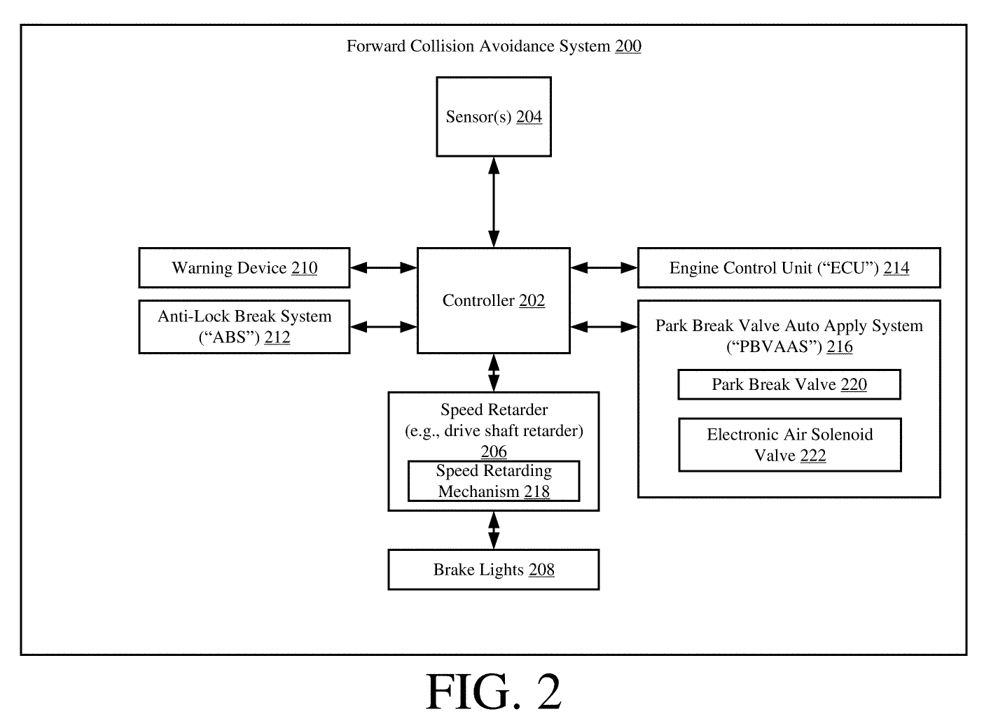

Referring now to FIG. 1, there is provided an illustration of an exemplary vehicle 100. Vehicle 100 has a vehicular collision avoidance feature. This vehicular collision avoidance feature is provided by a Forward Collision Avoidance System (“FCAS”) disposed in the vehicle 100. An exemplary architecture for an FCAS 200 is provided in FIG. 2. The FCAS 200 is generally configured to actuate a secondary braking system of the vehicle (referred to herein as a “speed retarder”) to decrease the speed of the vehicle. The FCAS 200 is designed to maintain a dynamically determined safe relative speed and following distance from another vehicle to avoid a collision or high/low speed impact with a moving or stationary object. It accomplishes this by automating control of the existing or added speed retarder, equipment and components already installed on or in the vehicle. The present solution requires no driver intervention. The electrical components of the FCAS 200 are powered by the vehicles power source (e.g., battery). For example, the battery supplies a voltage (e.g., 12 or 24 volts) to the FCAS 200. The present solution is not limited to the particulars of this example.

As shown in FIG. 2, the FCAS 200 comprises a controller 202, a sensor (e.g., a radar) 204, a speed retarder 206, brake lights 208, warning device (e.g., a light, a buzzer, and/or a speaker) 210, an Anti-lock Brake System (“ABS”) 212, an Engine Control Unit (“ECU”) 214, and a Park Brake Valve Auto Apply System (“PBVAAS”) 216. The controller 202 and speed retarder 206 are aftermarket components that are installed in the vehicle after the vehicle's sale to a consumer. Each of the listed components 204, 208-216 are well known in the art, and therefore will not be described in detail herein. Any known or to be known radar, brake light, warning device (e.g., light, buzzer or speaker), ABS, ECU and/or PBVAAS can be used herein without limitation. Notably, the FCAS 200 may include more or less components than that shown in FIG. 2.

During operation, the sensor(s) 204 generate(s) data indicating a detected distance between the vehicle and a possible obstruction (e.g., any vehicles or large objects) in front of the vehicle, a bearing to the possible obstruction, and/or other information indicating or useful for determining a time of collision or impact. In some scenarios, the sensor(s) 204 include(s), but is(are) not limited to, a radar, a vision sensor (e.g., a camera), and/or a LiDAR sensor mounted on or in (e.g., the front bumper of) the vehicle (e.g., via a connection through a wire harness and secured with a mounting bracket and hardware). The sensor(s) 204 is(are) configured to continually or periodically perform scans of a surrounding environment for purposes of detecting objects in front of the vehicle. The sensor(s) 204 provide(s) this generated data to the controller 202.

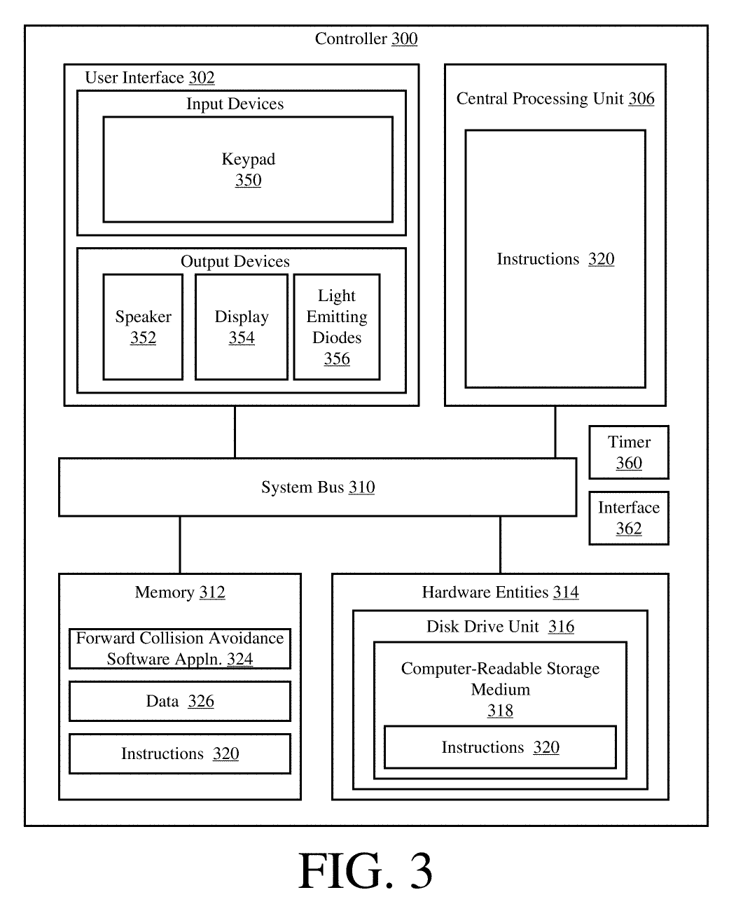

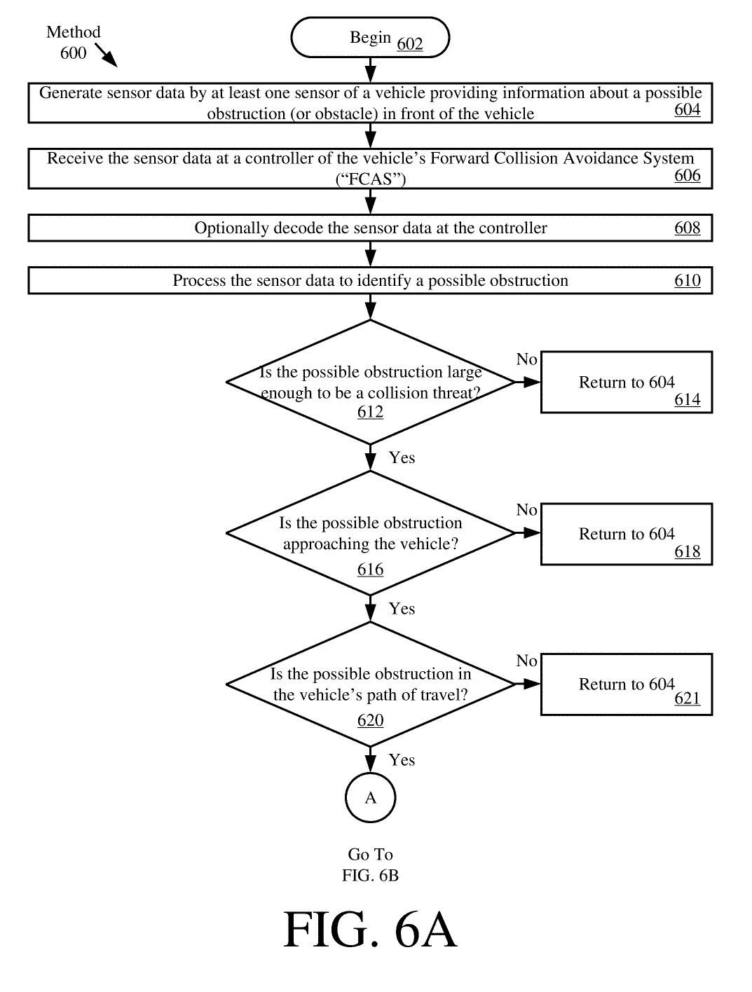

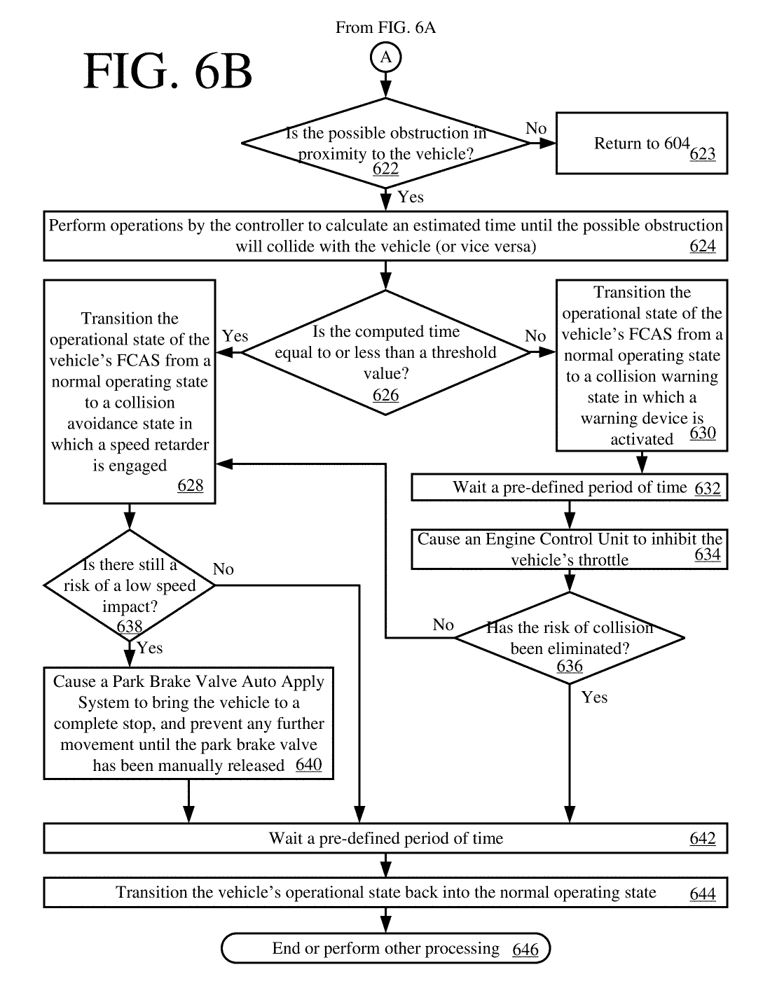

The controller 202 uses the received sensor data to identify potential obstructions with which the vehicle may collide based on pre-defined or pre-configured first parameters (e.g., the obstruction's size and/or the obstruction's location relative to the vehicle). In response to the identification of a potential obstruction, the controller 202 uses the data to determine if there is a risk of collision between the vehicle (e.g., vehicle 100 of FIG. 1) and the identified possible obstruction based on pre-defined or pre-configured second parameters. In some scenarios, this determination is based on the following information which can also be acquired by sensor(s) 204: the obstruction's size; the obstruction's location; the obstruction's direction of travel; the obstruction's speed of travel; the obstruction's path of travel; the vehicle's size; the vehicle's current location; the vehicle's current speed; the present vehicle's current direction of travel; the vehicle's path of travel; and/or the vehicle's current value of acceleration/deceleration. This determination may further be based on the driver's estimated reaction time (which may be based on historical driving related information collected for the driver's). A detailed block diagram of the controller 202 is provided in FIG. 3, which will be discussed below. Also, a flow diagram of an exemplary method for determining the collision risk will be discussed in detail below in relation to FIG. 6.

If it was determined that there is a risk (e.g., a>50% chance) that the vehicle will collide with the obstruction within a first amount of time (e.g., t₁>1 minute), then the controller 202 performs operations to: activate the warning device 210; start a timer; and/or monitor the time to detect when a pre-defined period of time (e.g., t₂=30 seconds) has expired during which the driver did not react to the warning device so as to reduce the closure rate between the vehicle and the possible obstruction. In response to the pre-defined period of time's expiration (i.e., the driver does not react to reduce the closure rate between the vehicle and the possible obstruction), the controller 202 performs operations to cause the ECU 214 to inhibit the vehicle's throttle (e.g., using a J1939 protocol). If the vehicle's speed continues to be high enough that the risk of collision has not been eliminated, then the controller 202 performs operations to engage the speed retarder 206 so that the vehicle's speed is decreased to a level that will avoid the collision (in a manner such as that disclosed below). In some scenarios, the value of the level is configurable to as low as 1.5 MPH.

If it was determined that there is a risk (e.g., a>50% chance) that the vehicle will collide with the obstruction within a second amount of time (e.g., t₁<1 minute), then the controller 202 performs operations to engage the speed retarder 206. In turn, the speed retarder 206 performs operations for (a) activating the brake lights 208 and (b) slowing down the vehicle's speed (without human intervention) in order to avoid an impending collision. The speed retarder's operations (b) are discontinued when the vehicle's speed is reduced to a predetermined value and/or the ABS 212 is engaged.

In this regard, the speed retarder 206 comprises a speed retarding mechanism 218 for causing the vehicle's speed to be slowed to a pre-set value (e.g., 5 miles per hour). Speed retarders are well known in the art, and therefore will not be described in detail herein. Any known or to be known speed retarder can be used herein without limitation. For example, the speed retarding mechanism can include, but is not limited to, a drive shaft retarding mechanism, an engine compression retarding mechanism, a transmission input or output retarding mechanism, and/or a driveline retarding mechanism. The speed retarding mechanism can be electric or hydraulic.

Electric retarders use electromagnetic induction to provide a retardation force. An electric retarder can consist of (a) a rotor attached to the axle, transmission or driveline and (b) a stator securely attached to the vehicle chassis. When retardation is required, the electrical windings of the stator receive power from the vehicle battery, producing a magnetic field through which the rotor moves. This induces eddy currents in the rotor, which produces an opposing magnetic field to the stator. The opposing magnetic fields slows the rotor, and hence the axle, transmission and driveshaft to which it is attached.

Hydraulic retarders use the viscous drag forces between dynamic and static vanes in a fluid-filled chamber to achieve retardation. A hydraulic retarder can consist of vanes attached to a transmission driveshaft between the clutch and roadwheels. The vanes are enclosed in a static chamber with small clearances to the chamber's vaned walls. When retardation is required, fluid is pumped into the chamber, and the viscous drag induced will slow the vehicle.

In some drive shaft retarding scenarios, an Electro-Magnetic Drive Shaft Retarding Mechanism (“EMDSRM”) applies torque to the main drive shaft of the vehicle in order to reduce the drive shaft's speed of rotation, and thus the speed by which the drive wheels of the vehicle are turning. The EMDSRM can include, but is not limited to, an axial retarder available from Telma Retarder, Inc. of Wood Dale, Ill.

In some engine compression retarding scenarios, a speed retarding mechanism inhibits the engine pistons so as to reduce the driveshaft's rotation seed, and thus the drive wheels' rotation speed. The driveshaft's rotation speed can also be reduced by reducing the output rotation speed of the transmission that is situated between the engine and the drive shaft.

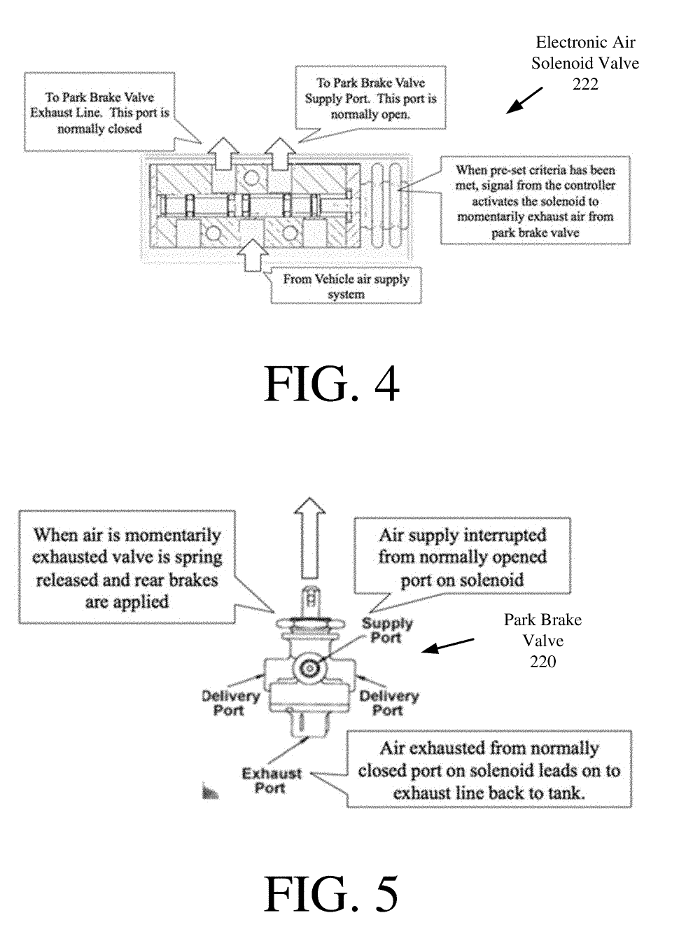

If there is still a risk of a low speed impact when the speed retarder 206 is engaged, then the controller 202 performs operations to cause the PBVAAS 216 to bring the vehicle to a complete stop. The PBVAAS 216 is also caused to prevent further movement of the vehicle until a park brake valve 220 has been manually released by the driver. Schematic illustrations that are useful for understanding how the park brake valve 220 is controlled are provided in FIGS. 4-5.

Referring now to FIG. 2, there is provided an illustration of an exemplary architecture for a controller 300. Controller 202 is the same as or substantially similar to controller 300. As such, the following discussion of controller 300 is sufficient for understanding controller 202 of FIG. 2.

Controller 300 may include more or less components than those shown in FIG. 3. For example, the controller can be provided with a coupling mechanism (e.g., a wire harness and/or mounting hardware) for coupling the same to an external object (e.g., the vehicle chassis). However, the components shown are sufficient to disclose an illustrative embodiment implementing the present solution. The hardware architecture of FIG. 3 represents one embodiment of a representative controller configured to facilitate forward collision avoidance. As such, the controller 300 of FIG. 3 implements at least a portion of a method for forward collision avoidance in accordance with the present solution.

Some or all the components of the controller 300 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 3, the controller 300 comprises a user interface 302, a Central Processing Unit (“CPU”) 306, a system bus 310, a memory 312 connected to and accessible by other portions of controller 300 through system bus 310, and hardware entities 314 connected to system bus 310. The user interface can include input devices (e.g., a keypad 350) and output devices (e.g., speaker 352, a display 354, and/or light emitting diodes 356), which facilitate user-software interactions for controlling operations of the controller 300. The output devices can be used to indicate system status (e.g., which operational state the vehicle is in at any given time).

At least some of the hardware entities 314 perform actions involving access to and use of memory 312, which can be a RAM, a disk driver and/or a Compact Disc Read Only Memory (“CD-ROM”). Hardware entities 314 can include a disk drive unit 316 comprising a computer-readable storage medium 318 on which is stored one or more sets of instructions 320 (e.g., software code) configured to implement one or more of the methodologies, procedures, or functions described herein. The instructions 320 can also reside, completely or at least partially, within the memory 312 and/or within the CPU 306 during execution thereof by the controller 300. The memory 312 and the CPU 306 also can constitute machine-readable media. The term “machine-readable media”, as used here, refers to a single medium or multiple media (e.g., a centralized or distributed database, and/or associated caches and servers) that store the one or more sets of instructions 320. The term “machine-readable media”, as used here, also refers to any medium that is capable of storing, encoding or carrying a set of instructions 320 for execution by the controller 300 and that cause the controller 300 to perform any one or more of the methodologies of the present disclosure.

In some scenarios, the hardware entities 314 include an electronic circuit (e.g., a processor) programmed for facilitating forward collision avoidance. In this regard, it should be understood that the electronic circuit can access and run a forward collision avoidance software application 324 installed on the controller 300. The controller 300 is generally operative to: receive data from one or more sensors (e.g., sensor(s) 204 of FIG. 2); store data 326 in a memory 312; compute value representing the risk of collision for the vehicle (e.g., vehicle 100 of FIG. 1); determine when the computed value is greater than a threshold value; perform operations to cause activation of a warning device (e.g., warning device 210 of FIG. 2); perform operations to cause an ECU (e.g., ECU 214 of FIG. 2) to inhibit the vehicle's throttle; start a timer 360; monitor the time to detect when a pre-defined period of time has expired during which the driver did not react to the warning device; and/or instruct a speed retarder (e.g., speed retarder 206 of FIG. 2) to activate brake lights (e.g., brake lights 208 of FIG. 2) and/or slow down the vehicle's speed in order to avoid an impending collision. Other functions of the software application 324 will become apparent as the discussion progresses.

The controller 300 further comprises an interface 362. The interface 362 facilitates programming of the controller and/or software/parameter updates.

Referring now to FIG. 6, there is provided a flow diagram of an exemplary method 600 for forward collision avoidance to be implemented in a vehicle (e.g., vehicle 100 of FIG. 1). Method 600 begins with 602 and continues with 604 where sensor data is generated by at least one sensor (e.g., sensor 204 of FIG. 2) of the vehicle. The sensor data provides information about a possible obstruction (e.g., a vehicle or object) in front of the vehicle. This information can include, but is not limited to, the obstruction's size, the obstruction's location, the obstruction's direction of travel, the obstruction's speed of travel, the obstruction's path of travel, the vehicle's current location, the vehicle's current speed, the vehicle's current direction of travel, the vehicle's path of travel, and/or the vehicle's current value of acceleration/deceleration.

Next in 606, the sensor data is received at a controller (e.g., controller 202 of FIG. 2 and/or 300 of FIG. 3) of the vehicle's FCAS (e.g., FCAS 200 of FIG. 2). If the sensor data is encoded, then the sensor data is decoded as shown by optional 608. At the controller, the sensor data is processed in 610 to identify a possible obstruction (i.e., object or other vehicle). When a possible obstruction is identified, one or more determinations are made as shown by 612-626 to determine if the vehicle's risk of collision with the possible obstruction.

In 612, a determination is made as to whether the possible obstruction is large enough to be a collision threat. In some scenarios, this determination is based on a sensed or configurable object size. If the possible obstruction is not large enough [612:NO], then 614 is performed where method 600 returns to 604. In contrast, if the possible obstruction is large enough [612:YES], then 616 is performed.

In 616, a determination is made as to whether the possible obstruction is approaching the vehicle. In some scenarios, this determination is made based on the relative speed between the vehicle and the possible obstruction. If the possible obstruction is not approaching the vehicle [616:NO], then 618 is performed where method 600 returns to 604. In contrast, if the possible obstruction is approaching the vehicle [616:YES], then 620 is performed.

In 620, a determination is made as to whether the possible obstruction is in the vehicle's path of travel. In some scenarios, this determination is made by comparing the object's lateral position with the vehicle's width. For example, a radar detects an object five (5) feet to the right of the vehicle. However, a collision warning is not triggered in this case since the object is not in the vehicle's path of travel. Accordingly, if the possible obstruction is not in the vehicle's path of travel [620:NO], then 621 is performed where method 600 returns to 604 so that more sensor data is acquired. In contrast, if the possible obstruction is in the vehicle's path of travel [620:YES], then method 600 continues with 622 of FIG. 6B.

As shown in FIG. 6B, 622 involves determining if the possible obstruction is in proximity to the vehicle. If not [622:NO], then 623 is performed where method 600 returns to 604 so that more sensor data is acquired. If so, then 624 is performed.

624 involves performing operations by the controller to calculate an estimated time until the possible obstruction will collide with the vehicle (or vice versa). In some scenarios, this computation is based on the approaching object's speed relative to the vehicle. The computed estimated time of collision is then compared to a threshold value as shown by 626. The threshold value can be selected based on an effectiveness of a speed retarder (e.g., speed retarder 206 of FIG. 2), an effectiveness of the foundation brakes, and/or the driver's reaction time.

If the computed estimated time of collision is equal to or less than the threshold value [626:YES], then 628 is performed where an operational state of the vehicle's FCAS is transitioned from a normal operating state to a collision avoidance state in which the speed retarder (e.g., speed retarder 206 of FIG. 2) is engaged. When the speed retarder is engaged, at least a drive shaft retarder (e.g., drive shaft retarder 218 of FIG. 2) is activated in calculated degrees of retardation so as to provide active forward collision avoidance.

In an environment where simply slowing the vehicle down to a lower speed does not avoid a low speed impact [638:YES], the controller performs operations to cause a PBVAAS (e.g., PBVAAS 216 of FIG. 2) to bring the vehicle to a complete stop. The PBVAAS is also caused to prevent any further movement until the park brake valve (e.g., park brake valve 220 of FIG. 2) has been manually released.

Upon completing 640 or in the case that there is no risk of a low speed impact after the speed retarder has been engaged [638:NO], 642 is performed where the system waits a pre-defined period of time. Next in 644, the vehicle's operational state is transitioned back into the normal operating state in which the speed retarder is not engaged and the warning device is deactivated. Subsequently, 646 is performed where method 600 ends or other processing is performed.

In contrast, if the computed estimated time of collision is equal to or less than the threshold value [626:YES], then 630 is performed where the operational state of the vehicle's FCAS is transitioned from its normal operating state to a collision warning state in which a warning device (e.g., warning device 210 of FIG. 2) is activated. The waring device may be mounted on the vehicle's dashboard, connected to the vehicle's power source and secured in a manner that will ensure that the driver receives the warning (audible, visual or tactile) without interfering with any vehicle operations or violating any regulations. Notably, the present solution is not limited to the use of a single threshold value. For example, two different threshold values can be used in order to determine when the operational state of the vehicle should enter into a collision avoidance state or a collision warning state.

Next, 632-634 are performed where: the system waits a pre-defined period of time; and an ECU (e.g., ECU 214 of FIG. 2) is caused to inhibit the vehicle's throttle. Thereafter, a determination is made as to whether or not the risk of collision has been eliminated. If the risk of collision has not been eliminated [636:NO], then method 600 continues with 628-640 which are described above. In contrast, if the risk of collision has been eliminated [636:YES], then the system waits a pre-defined period of time as shown by 642. Thereafter, 644 is performed where the vehicle's operating state is transitioned back into its normal operating state in which the EMDSR is not engaged and the warning device is deactivated. Subsequently, 646 is performed where method 600 ends or other processing is performed.

In view of the forgoing discussion, the present solution concerns systems and methods for an automated control of a speed retarder in order to avoid an imminent collision risk. The speed retarder is engaged to activate at least a drive shaft retarder (e.g., drive shaft retarder 218 of FIG. 2) in calculated degrees of retardation when a collision threat is detected or determined to exist.

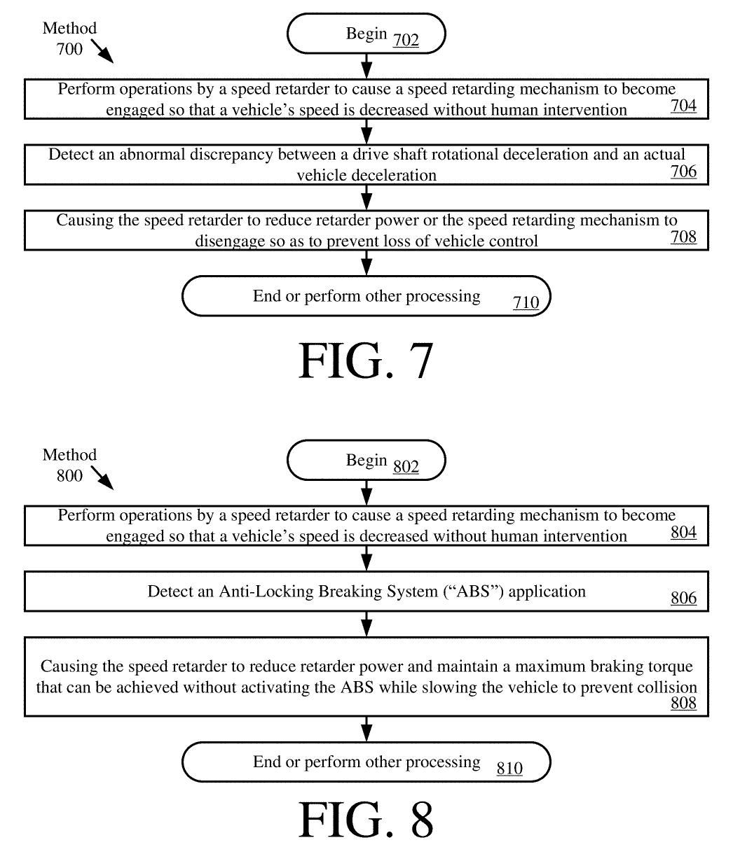

Referring now to FIG. 7, there is provided a flow diagram of an exemplary method 700 for operating a speed retarder (e.g., speed retarder 206 of FIG. 2). In this case, the speed retarder has a supplemental anti-lock function. Notably, method 600 can be modified in view of method 700. For example, the operations of 704-708 of FIG. 7 can be inserted between 628 and 638 of FIG. 6B.

As shown in FIG. 7, method 700 begins with 702 and continues with 704 where operations are performed by the speed retarder to cause a speed retarding mechanism (e.g., speed retarding mechanism 218 of FIG. 2) to become engaged so that a vehicle's (e.g., vehicle 100 of FIG. 1) speed is decreased without human intervention. For example, an EMDSRM engages and applies torque to the main drive shaft of the vehicle in order to reduce the drive shaft's speed of rotation, and thus the speed by which the drive wheels of the vehicle are turning.

Next in 706, the controller (e.g., controller 204 of FIG. 2) performs operations to detect an abnormal discrepancy between a drive shaft rotational deceleration and an actual vehicle deceleration. This detection can be achieved using acceleration/deceleration data generated by a sensor. For example, an accelerometer in an Inertial Motion Unit (“IMU”) can be used to detect and measure acceleration due to an actual change in velocity of the vehicle during EMDSR activation. The IMU can be part of the controller or a component separate from the controller (e.g., a sensor 204 of FIG. 2). The acceleration/deceleration data is then processed to determine whether the change is comparable to the rate of rotational acceleration (i.e., speed change) of the driveshaft. If the change is not comparable to the rate of rotational acceleration, then an abnormal discrepancy is deemed to exist. The present solution is not limited to the particulars of this example.

Upon completing 706, 708 is performed where the speed retarder is caused to reduce retarder power or the speed retarding mechanism is disengaged so as to prevent loss of vehicle control. It is well known that the coefficient of static friction is greater than the coefficient of sliding friction. This fundamental scientific principle requires that the rotational speed reductions of the speed retarding mechanism be such as to not be so large as to cause the drive wheels to skid. Skidding can be detected by comparing the rotational speed of the drive wheels with the speed of the vehicle. Once detected, retarder power is reduced such that skidding is averted and controlled at a maximum level such that skidding continues to be averted. Subsequently, 710 is performed where method 700 ends or other processing is performed.

Referring now to FIG. 8, there is provided a flow diagram of an exemplary method 800 for operating a speed retarder (e.g., speed retarder 206 of FIG. 2). In this case, the speed retarder has a supplemental ABS function. Notably, method 600 can be modified in view of method 800. For example, the operations of 804-808 of FIG. 8 can be inserted between 628 and 638 of FIG. 6B.

As shown in FIG. 8, method 800 begins with 802 and continues with 804 where operations are performed by the speed retarder to cause a speed retarding mechanism (e.g., speed retarding mechanism 218 of FIG. 2) to become engaged so that a vehicle's (e.g., vehicle 100 of FIG. 1) speed is decreased without human intervention. For example, an EMDSRM engages and applies torque to the main drive shaft of the vehicle in order to reduce the drive shaft's speed of rotation, and thus the speed by which the drive wheels of the vehicle are turning.

Next in 806, the controller (e.g., controller 204 of FIG. 2) performs operations to detect an ABS application. ABS application is the automated process that is contained in braking systems that prevents the application of standard disk or rotor brakes being applied with such force that the wheels begin to skid. If both standard brakes and a retarder are being applied to decelerate the vehicle, then it is the combination of these forces that need to be controlled at the highest level without causing the wheel to slip. This portion of the controller allows the normal brake to be used at its maximum by decreasing the retarder's contribution to a level that is just below the skid point, thus allowing the normal brakes to be used at their maximum. In response to this detection, the controller performs operations in 808 to cause the speed retarder to reduce retarder power and maintain a maximum braking torque that can be achieved without activating the ABS while slowing the vehicle to prevent collision. Subsequently, 810 is performed where method 800 ends or other processing is performed.

In some scenarios, the speed retarder (e.g., speed retarder 206 of FIG. 2) has a manual sensitivity control. This control allows drivers to set collision avoidance sensitivity based on one or more parameters. These parameters include, but are not limited to, actual gross vehicle weight, observed conditions, and/or personal preferences.

In those or other scenarios, the FCAS (e.g., FCAS 200 of FIG. 2) employs adaptive collision avoidance. In this case, operating parameters of the FCAS are automatically and dynamically adjusted based on sensed driver response time, traction and braking effectiveness. This parameter adjustment can account for varying vehicle weights and operating conditions. By measuring how soon after activation of a collision warning device (e.g., a light, vibrator, or speaker) the driver released the throttle and applied the brake, the controller (e.g., controller 204 of FIG. 2) statistically determines effective driver response time. By measuring actual vehicle deceleration achieved for a given retarder power level or brake application, the controller automatically adjusts collision warning and avoidance parameters to account for actual vehicle weight, traction, braking performance and retarder effectiveness.

It will be apparent to those skilled in the field of commercial vehicle operations that there can be various system configurations and user adaptations to the operation of the present solution. It will also be apparent to those in the field of maintenance and repair that there can be various modifications and variations made to the installation and programming methods without departing from the scope or spirit of the present invention.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application. Thus, the breadth and scope of the present invention should not be limited by any of the above described embodiments. Rather, the scope of the invention should be defined in accordance with the following claims and their equivalents.

What is claimed is:

1. A method for controlling a speed of a vehicle, comprising:
obtaining sensor data from at least one sensor of the vehicle by an aftermarket electronic controller that was installed in the vehicle after the vehicle's sale to a consumer;
processing, by the aftermarket electronic controller, the sensor data to determine if there is a collision risk of the vehicle colliding with a possible obstruction;
calculating, by the aftermarket electronic controller, an estimated time until the possible obstruction and the vehicle will collide with each other, when a determination is made that there is a collision risk;
performing first operations by the aftermarket electronic controller to transition an operational state of the vehicle to a collision warning state in which a warning device is activated for outputting a visual, tactile or auditory collision warning, when the estimated time is greater than a threshold value; and
performing second operations by the aftermarket electronic controller to transition the operational state of the vehicle to a collision avoidance state in which a speed retarder is engaged so as to slow a speed of the vehicle without human intervention and without reliance on the vehicle's foundation braking system, when the estimated time is less than the threshold value.

2. The method according to claim 1, wherein the risk is determined based on at least one of a size of the possible obstruction, changes in a distance between the vehicle and the possible obstruction, a path of travel of the vehicle, and the possible obstruction's relative distance to the vehicle at a given time.

3. The method according to claim 1, wherein a park brake valve auto apply system is caused to bring the vehicle to a stop if the collision risk still exists after the speed retarder has been engaged.

4. The method according to claim 1, further comprising performing operations by the aftermarket electronic controller to cause an engine control unit to inhibit the vehicle's throttle when a pre-defined period of time has expired after the operational state of the vehicle is transitioned to the collision warning state.

5. The method according to claim 4, further comprising:
determining if the collision risk has been eliminated as a result of the vehicle's throttle inhibition; and
transitioning the operational state of the vehicle from the collision warning state to the collision avoidance state of the collision risk has not been eliminated as a result of the vehicle's throttle inhibition.

6. The method according to claim 1, further comprising:
detecting an abnormal discrepancy between a drive shaft rotational deceleration and an actual vehicle deceleration; and
causing the speed retarder to reduce retarder power or become disengaged in response to the detection of the abnormal discrepancy.

7. The method according to claim 1, further comprising:
detecting application of an anti-locking braking system; and
causing the speed retarder to reduce retarder power and maintain a maximum achievable braking torque without activating the anti-locking braking system while slowing the vehicle to prevent collision.

8. The method according to claim 1, further comprising performing operations by the aftermarket electronic controller to automatically and dynamically modify at least one operating parameter based on at least one of a vehicle weight, a sensed driver response time, a tire's traction and a braking effectiveness.

9. The method according to claim 1, further comprising receiving a user-software interaction for setting a collision avoidance sensitivity of the aftermarket electronic controller.

10. The method according to claim 1, wherein the speed retarder comprises an Electro-Magnetic Drive Shaft Retarding Mechanism (“EMDSRM”) configured to apply torque to a main drive shaft of the vehicle in order to reduce the main drive shaft's speed of rotation.

11. An aftermarket electronic controller, comprising:
a processor;
a non-transitory computer-readable storage medium comprising programming instructions that are configured to cause the processor to implement a method for inventory management, wherein the programming instructions comprise instructions to:
receive sensor data generated by at least one sensor of a vehicle;
process the sensor data to determine if there is a collision risk of the vehicle colliding with a possible obstruction;
calculate an estimated time until the possible obstruction and the vehicle will collide with each other, when a determination is made that there is a collision risk;
transition an operational state to a collision warning state in which a warning device is activated for outputting a visual, tactile or auditory collision warning, when the estimated time is greater than a threshold value; and
transition the operational state to a collision avoidance state in which a speed retarder is engaged so as to slow a speed of the vehicle without human intervention and without reliance on the vehicle's foundation braking system, when the estimated time is less than the threshold value.

12. The aftermarket electronic controller according to claim 10, wherein the risk is determined based on at least one of a size of the possible obstruction, changes in a distance between the vehicle and the possible obstruction, a path of travel of the vehicle, and the possible obstruction's relative distance to the vehicle at a given time.

13. The aftermarket electronic controller according to claim 10, wherein a park brake valve auto apply system is caused to bring the vehicle to a stop if the collision risk still exists after the speed retarder has been engaged.

14. The aftermarket electronic controller according to claim 10, wherein the programming instructions further comprise instructions to cause an engine control unit to inhibit the vehicle's throttle when a pre-defined period of time has expired after the operational state of the vehicle is transitioned to the collision warning state.

15. The aftermarket electronic controller according to claim 14, wherein the programming instructions further comprise instructions to:
determine if the collision risk has been eliminated as a result of the vehicle's throttle inhibition; and
transition the operational state of the vehicle from the collision warning state to the collision avoidance state of the collision risk has not been eliminated as a result of the vehicle's throttle inhibition.

16. The aftermarket electronic controller according to claim 10, wherein the programming instructions further comprise instructions to:
detect an abnormal discrepancy between a drive shaft rotational deceleration and an actual vehicle deceleration; and
cause the speed retarder to reduce retarder power or become disengaged in response to the detection of the abnormal discrepancy.

17. The aftermarket electronic controller according to claim 10, wherein the programming instructions further comprise instructions to:
detect application of an anti-locking braking system; and
cause the speed retarder to reduce retarder power and maintain a maximum achievable braking torque without activating the anti-locking braking system while slowing the vehicle to prevent collision.

18. The aftermarket electronic controller according to claim 10, wherein the programming instructions further comprise instructions to automatically and dynamically modify at least one operating parameter based on at least one of a vehicle weight, a sensed driver response time, a tire's traction and a braking effectiveness.

19. The aftermarket electronic controller according to claim 10, wherein the programming instructions further comprise instructions to set a collision avoidance sensitivity in response to a user-software interaction.

20. The aftermarket electronic controller according to claim 10, wherein the speed retarder comprises an Electro-Magnetic Drive Shaft Retarding Mechanism (“EMDSRM”) configured to apply torque to a main drive shaft of the vehicle in order to reduce the main drive shaft's speed of rotation.
